(19) United States
(12) Patent Application Publication
(10) Pub. No.: US 2014/0160135 A1
(43) Pub. Date: Jun. 12, 2014

(54) Memory Cell Array with Dedicated Nanoprocessors

(71) Applicant: Scott A. Krig, Santa Clara, CA (US)

(72) Inventor: Scott A. Krig, Santa Clara, CA (US)

(21) Appl. No.: 13/993,743

(22) PCT Filed: Dec. 28, 2011
(86) PCT No.: PCT/US2011/067459

§ 371 Date: Jun. 13, 2013

(51) Int. Cl. G06T 1/20; G06F 9/38

(52) U.S. Cl. CPC G06T 1/20; G06F 9/3885
USPC 345/505

(57) ABSTRACT

A processing architecture uses stationary operands and opcodes common on a plurality of processors. Only data moves through the processors. The same opcode and operand is used by each processor assigned to operate, for example, on one row of pixels, one row of numbers, or one row of points in space.

### BACKGROUND

This relates generally to processing architectures and particularly to processing architectures adapted for parallel operations on a large amount of data.

In many processing applications, including those involving graphics and those involving complex mathematical calculations, a large number of simple operations must be done a large number of times. As a result, many of these operations can be done in parallel.

In a typical Von Neumann architecture, a processing pipeline is executed by a processor. In that pipeline, there are number of stages. Both data to be operated on and code to operate on that data, move through the pipeline in parallel. That is, both the instructions and the data move from stage to stage through the pipeline in the same way.

### BRIEF DESCRIPTION OF THE DRAWINGS

Some embodiments are described with respect to the following figures:

FIG. 1 is a hardware depiction of one embodiment;

FIG. 2 is a sequential depiction of a write operation according to one embodiment;

FIG. 3 is a flow chart for the write operation in one embodiment;

FIG. 4 is a sequential depiction of a read operation according to one embodiment; and

FIG. 5 is a flow chart for a read operation in one embodiment.

### DETAILED DESCRIPTION

In some embodiments an instruction stream does not need to be fetched in contrast to the Von Neuman architecture. Instead, instructions and operands are preset into the control and operand registers, and only the data stream needs to be fetched. In some cases this is advantageous for speed of calculations and reduction of memory bandwidth requirements.

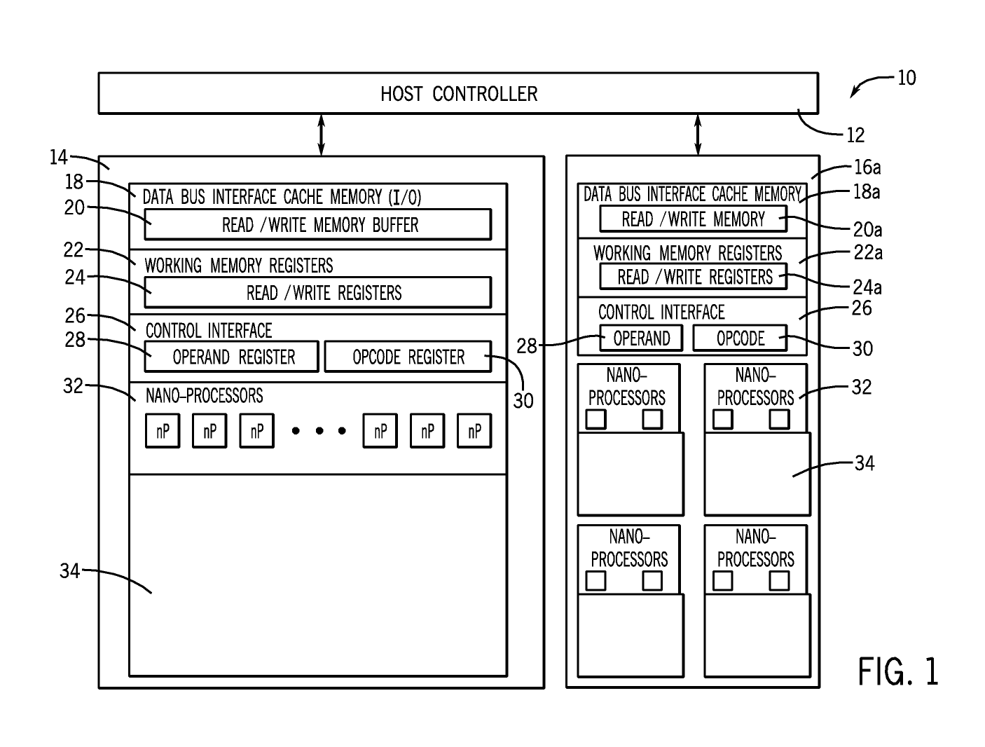

Referring to FIG. 1, in accordance with one embodiment, a host controller 12 may be coupled to an orthogonal processor 14 and an orthogonal processor 16a. The difference between the two processors 14 and 16a is that one works on a smaller sized word than the other. Specifically, the orthogonal processor 14 in one embodiment works on 4k words while the orthogonal processor 16a in one embodiment works on 16k words. Other arrangements are also possible. Thus, there may be additional orthogonal processors, each adapted to different word sizes, and there is no limitation on the particular word sizes that any particular processor may be designed to operate on.

As used herein, an orthogonal processor refers to the fact that the data and instructions do not move through the processor along the same path. Instead, a given word of work is broken into a given number of bits to form a data word. A nanoprocessor is provided to operate on each of the groups of bits (data words) in parallel. Thus to operate on a 4k word, there would be 4k nanoprocessors in one embodiment. Each nanoprocessor may use a common or shared operating register 28 and a common opcode register 30 because each nanoprocessor is doing the same operation using the same operand as all the other nanoprocessors in a given orthogonal processor.

The output of each nanoprocessor 32 is stored in a row in the cell array 34 which is a two-dimensional memory with rows and columns. A nanoprocessor is any relatively small limited function or dedicated processor.

The way that these operations are implemented is equivalent to a direct memory access (DMA). Thus the operations occur at memory write speeds in some embodiments, and faster or slower in other embodiments.

Opcode register 30 stores an opcode that is then used by each nanoprocessor to operate on the input data. In some embodiments there may be more than one opcode that is applied to the data. Thus, in some embodiments more than one opcode register may be included. This results in the same data being operated on by more than one opcode. In some embodiments the opcode register 30 may store compound opcodes such as fused multiply add opcodes. In such cases, more than one opcode occurs together in the same instruction. Thus, the opcode register may include opcodes fused together to perform both a multiply and an add in the same instruction. Other fused operations include multiply and clip in the same instruction, and add and clip in the same instruction using a plurality of opcode registers. Other compound opcodes may also be used.

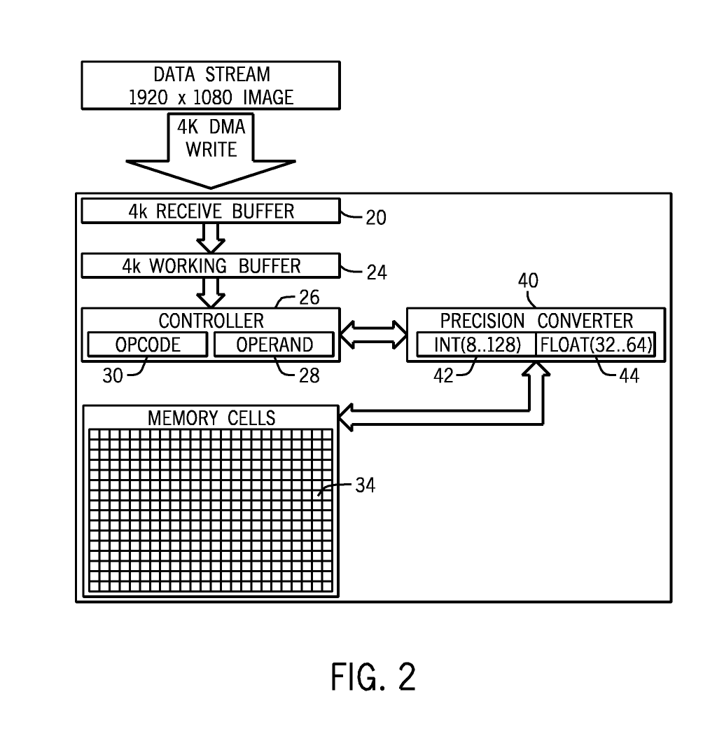

Referring to FIG. 2, in an orthogonal processor, data moves in the vertical direction and operands and opcodes are moving or set into one or more operand and opcode registers in the horizontal direction in each nanoprocessor. The operands and opcodes are stored before the data flow begins.

Thus the sequence may be, in one embodiment, to provide a word of data having a number of bits equal to the number of nanoprocessors. Each nanoprocessor has access to the particular operands and the particular opcodes to be executed any given number of times. Thus a two dimensional array of data may include a number of horizontal rows of data. Each row may be processed serially, one after the other. Therefore the nanoprocessors do not need to receive new opcodes or operands until after the entire two dimensional array has been processed.

Once each nanoprocessor has access to the correct operands and the correct opcodes and has the data ready to operate on, the operation is implemented. For example if the operation is a multiply, each nanoprocessor does the multiplication and loads the data into a row of the cell array 34. Thus the operations are done effectively at write speeds corresponding to direct memory accesses. Each cell in the array stores the result of the operation performed on one bit or data word, such as one pixel in a graphics application.

The host controller feeds the data to each orthogonal processor 14 or 16a as the case may be. Thus if a given set of operations uses words of one size, the data may be provided to the processor 14, and if the data is of a different size it may be provided to a processor 16a adapted to that particular size.

Typically, embodiments of the present invention operate on point operations which are basically one-dimensional. A multiply or an add is an example of a point operation. Area operations involve two or more dimensions and correspond to things like kernel operations, convolutions, and binary morphology.

Applications for two-dimensional operations include discrete convolution and kernel operations include media post-processing, camera pipeline processing, video analytics, machine vision and general image processing. Key operations may include edge detection and enhancement, color and luminance enhancement, sharpening, blurring, and noise removal.

Applications of binary morphology as two-dimensional area operations include video analytics, object recognition, object tracking and machine vision. Key operations performed in the orthogonal processor may include a erode, dilate, opening and closing.

Applications for numeric area and point operations include any type of image processing including those described above in connection with discrete convolution, kernel operations, and binary morphology. Key operations include math operators, Boolean operators applied to each point or pixel and numeric precision data type conversions.

In some embodiments area operations are converted into point operations, where area operations may be two or three cubic, or higher dimensions, and the reduction of said area operations into one-dimensional point operations is advantageous in some embodiments reducing the computational and memory bandwidth overhead for all point operations. For example, a convolution is an area operation that can be converted into a series of successively shifted multiplications with accumulation, which are simple one-dimensional point operations that are accelerated. Then in the first pass through an orthogonal processor, a shift in the dataset origin is implemented and in the second pass, a multiplication may be implemented with accumulation on a shifted version of the source dataset.

In a more specific example, the operation may be accumulation or summing. Each orthogonal processor cell is an accumulator that sums the results of each memory write into itself by combining the write value or operand according to an opcode. Only a write into memory is needed for the memory cell to perform the computation. At page writes and corresponding vectorization of computations such as 4,096 page writes and 4,096 vectorized operations may occur a direct memory access speeds. In this example, the memory cell is the accumulator for a set of sequential operands, and the cumulative result of a set of operations is accumulated in the memory cell, for example, a set of nine (9) MULTIPLY-ADD instructions used to implement a convolution kernel where the result is accumulated into the memory cell.

The memory cell may also used as an operand for some operations or opcodes. An opcode may take as an input a memory cell and an operand from a register, where the result is stored into the memory cell, for example, as may be the core with a MULTIPLY-ADD instruction.

Each nanoprocessor may operate as follows in one embodiment. For each opcode, the operation bit precision and numeric conversion is defined. Assuming a 32-bit opcode embodiment, there are zero to fifteen bits to define the opcode and sixteen to twenty-one bits to define the precision and conversion of the operation. The decoding of the instructions may occur in an orthogonal path to the data path.

Accumulation may effectively be done in the cell array 34. Opcodes may be implemented in the nanoprocessors 32 and numeric conversions may occur on read or write to each memory cell. Each memory cell applies a data format conversion operation as follows. For read operations, the cell numeric format is converted on memory read using a convert operator. Numeric conversions can be specified using an opcodes or convert operations to set up the nanoprocessors prior to the memory reads or writes to enforces the desired data conversion and numeric precision. The numeric conversions are implicit and stay in effect until a new opcode is sent to the nano processors. For write operations, a final value is converted to a desired numeric format according to the convert operator. This allows any sort of common operation to be implemented such as area convolution, point operations, binary morphology, with options available to be set into control or opcode registers to specify the numeric conversions between float, double, and integer. In some embodiments precision may be fixed or limited to save silicon real estate and to reduce power consumption.

The cell array is an array of memory cells or registers with attached compute capabilities in the form of the nanoprocessors shown in FIG. 1. Each memory cell is also an accumulator storing results with varying precision calculated by the nanoprocessors. Cell array processing occurs at the speed of memory writes eliminating memory reads for kernels and source pixels and providing vectorized processing at the speed of direct memory access writes into the cell array in some embodiments.

The array can be used simply for data conversions instead of calculations, since data conversions are very common, and the array can accelerate them.

An array can also be used for memory read operations simply for numeric conversions via DMA reads, since the numeric conversions are fast and occur at DMA rates with no need for processing the data. The numeric conversions may be between integer and floating point, various integer lengths, and various floating point lengths using sign extension, rounding, truncation, and other methods as may be desired and set using opcodes.

The cell array operation is similar to a hardware raster operation in a display system. In a display system, the raster operations are applied for each pixel written into a display memory cell or pixel.

For example in connection with a convolution, a series of pixel offset writes can occur into the orthogonal processor memory cells where the desired operation for each pixel may occur within the nanoprocessors that act on the individual cells. Each kernel value is preset into the cell array operand register prior to the pixel blit. The cell array operates by simply writing the entire image which causes the nanoprocessors to perform convolution operations for each pixel. This arrangement transfers pixel by pixel area convolution into a vectorized write operation, eliminating kernel and pixel reads and performing a fused multiply-add accumulation in each cell.

The orthogonal processor may perform 3×3 convolution with nine pixel writes of the image frame onto itself and offsets according to the kernel size, eliminating explicit read operations. In contrast a normal 3×3 convolution involves nine kernel reads, nine pixel reads and nine diffuse (remove diffuse, used fused) fused multiply-add instructions for each pixel in addition to a final pixel write. Thus the orthogonal processor may provide a significant speed-up in some embodiments. The pseudo code for 3×3 convolution using nine image frame writes plus kernel set-up is as follows:

```
sobel[3][3] =
{
{−1,  −2,  −1,}
{ 0,  0,  0,}
{ 1,  2,  1}
};
// Initialize cells by writing entire image into XCELLARRAY
writeImage(source_image, &xcellarrray.memory, /*X OFFSET*/ 0,
/*Y OFFSET */ 0);
// Initialize opcode register with MULTIPLY
Xcellarray.opcode = OP_MULTIPLY;
// Iterate 9 times to write the entire image, one line at a time, into the
memory array
// and for each write, use a different kernel value
XSIZE = 3;
YSIZE = 3;
XOFFSET = (XSIZE / 2);
YOFFSET = (YSIZE / 2);
for (x=0; x < XSIZE; x++)
{
  for (y=0, y < YSIZE; y++)
  {
  // Initialize operand register with the current kernel value [x,y]
  Xcellarray.operand[0] = sobel[x,y];
  // Write source image into cell array at the offset for each kernel
  element
  // This Write performs a MADD instruction -> CELL += (CELL *
  operand) writeImage(source_image, &xcellarrray.memory,
  x - XOFFSET, y - YOFFSET);
  }
}
```

The example below shows pseudo-code for a 3×3 morphological DILATE operation illustrating the cell array optimization method according to one embodiment.

```
dilate[3][3] =
{
{ 0,  1,  0,}
{ 1,  0,  1,}
{ 0,  1,  0}
};
// Initialize cells by writing entire image into
writeImage(source_image, &xcellarrray.memory, /*X OFFSET*/ 0, /*Y
OFFSET */ 0);
// Initialize opcode register with MULTIPLY
Xcellarray.opcode = OP_OR; // Boolean OR
// Iterate 9 times to write the entire image into the memory array
// and for each write, use a different kernel value
XSIZE = 3;
YSIZE = 3;
XOFFSET = (XSIZE / 2);
YOFFSET = (YSIZE / 2);
for (x=0; x < XSIZE; x++)
{
  for (y=0, y < YSIZE; y++)
  {
    // OPTMIIZATION: for DILATE, we only use truth values of 1
    (ignore 0)
    if (dilate[x,y] != 0)
    {
      // Initialize operand register with the current kernel value [x,y]
      Xcellarray.operand[0] = dilate[x,y];
      // Write source image into memory array at the offset for each
kernel element
      // This Write performs a MADD instruction -> CELL += (CELL *
      operand)
      writeImage(source_image, &xcellarrray.memory, x - XOFFSET,
y - YOFFSET);
    }
  }
}
```

Each cell in the memory 34 contain the following three features: 1) accumulation or summing into the cell, 2) operations or opcodes that act on the cell and a set of operands in programmable registers, and 3) numeric and data format conversions between various integer and floating point data types and bit resolutions.

In an embodiment, a specific set of opcodes may be implemented as needed to suit a specific task, incluing mathematical operations, Boolean logic operations, logical comparison operations, data conversion operations, transcendental function operations, or other operations that may be devised by one skilled in the art.

The nanoprocessors provide a set of mathematical and logical operations and numeric format conversions using an input operand and the current cell value accumulated in the cell as shown below in equation 1, where one or more operands may be used in an embodiment:

Cell=Precision (Opcode(Cell*Operand1 . . . Operandn)) Equation 1:

where:
Cell=existing value of the memory cell
Operand 1 . . . n: values to combine with the cell value via the opcode
Opcode: *math (+,−,*,/, ∥, . . . ) or Boolean (AND, OR, NOT, XOR) result accumulated in cell
Precision: numeric format conversions int(8,10,12,14,16,24,32,64), float(24,32,64), etc.

Each memory cell is an accumulator, and sums the results of each memory write into itself by combining the write value (operand) according to an opcode. Only a write into memory is needed for the memory cell to perform the computations, which allows DMA rate page writes and corresponding vectorization of computations, such as 4096 page writes and 4096 vectorized operations.

An opcode may use one or more operands. For example, a Write opcode operation using a single operand may include the following instruction format:
MADD cell=(cell*in+cell)
ADD cell=(cell+in)
SUBTRACT cell=(cell−in)
MULTIPLY cell=(cell*in)
DIVIDE cell=(cell/in)
XOR cell=(cell̂in)
OR cell=(cell|in)
AND cell=(cell*in)
NOR cell=(!(cell|in))
NAND cell=(!(cell*in))
CONVERT (INT<->FLOAT, resolution, truncation, etc.—this is a part of opcode)
OPERAND (the incoming value being written into the cell)

An example of an opcode using multiple operands in an embodiment could be an ADDCLIP instruction as follows:

### ADDCLIP OPERAND1 OPERAND2 CELL

### Where:

OPERAND1=value to add to the cell
OPERAND2=value to clip the addition result, so that the result cannot be larger than OPERAND2
CELL=the memory cell where the addition result is stored
   And the equation or pseudo code showing this operation is:
RESULT=CELL+OPERAND1
IF (RESULT>OPERAND2) RESULT=OPERAND2//clipped result ‘CELL=RESULT

Each memory cell applies a data format conversion operation using the convert operation as follows. For read operations convert cell numeric format on memory read using convert operation. For write operations convert final value to desired numeric format according to convert operator. This allows any sort of common operation to be implemented such as area convolution, point operations, binary morphology, numeric conversions between float, double, int, etc.

In some embodiments, multiformat read and multiformat writes may be supported. This allows various numeric precisions to be used and converted on the fly. Numeric formats may include integer and float of various bit sizes. In one embodiment, only a subset of the numeric formats may be implemented to save silicon real estate and reduce power consumption. For example, one embodiment may support only integer (8, 12, 16, 32 bits) and float (24, 32 bits) numeric formats and conversions.

Each cell may store numeric data in an appropriate canonical numeric format to support the numeric conversions. The canonical format may vary in some embodiments.

Each memory cell in the array may have a dedicated nanoprocessor. However in other embodiments, a single vector of nanoprocessors corresponding to the memory page width may be shared among all the cells to support direct memory access page writes of 4,096 words together with the necessary processing. Thus some embodiments allow a single vector processing unit of a given size to be shared among vectors of memory cells rather than actually providing a dedicated nanoprocessor at each cell.

FIG. 2 shows a streaming calculation by a direct memory access write operation. In this example, the data stream may be a 1920×1080 image. A portion of the width of the image in one embodiment a 4K portion is written to the receive buffer 20 as indicated by the write arrow in FIG. 2. That 4K chunk is then moved to the working buffer 24 and another 4K chunk may be read across the width of the data stream to get it ready for subsequent operations in the controller. Across the width of the data stream to get it ready for subsequent operations in the controller. In the controller 26, there may be in one embodiment be 4K nanoprocessors each with an opcode 30 and an operand 28. Thus, a controller may include a nanocontroller for each bit of the chunk in one embodiment. It may also transfer each bit to the precision converter which changes either the precision or the type of data from integer to float or from float to integer. Then the data is stored into a row of memory cells in the memory array 34.

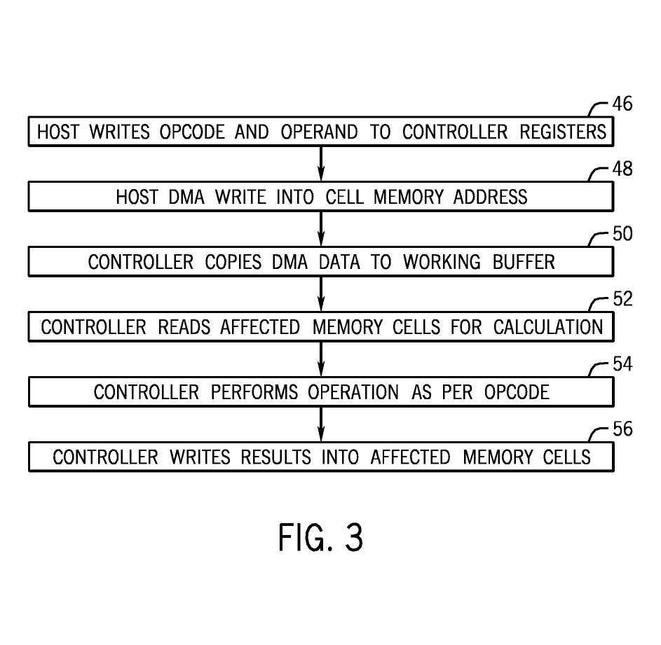

Thus referring to FIG. 3, a sequence may be implemented in hardware, software and/or firmware. In software and firmware embodiments it may be implemented by computer executed instructions stored in a non-transitory computer readable medium such as an optical, magnetic or semiconductor memory. For example, the sequence of instructions may be stored in the controller 26 in FIG. 2 in one embodiment.

The sequence begins when the host controller 12 (FIG. 1) writes the opcode and operand to the controller 26 registers as indicated in block 46. The block code contains a bit precision information. In some embodiments, there may be multiple operands.

Then the host does a DMA write into a cell memory address as indicated in block 48. More particularly data may be copied into a receive buffer for calculations prior to going into the cell memory.

Next the controller 26 copies the DMA data into the working buffer 24 in FIG. 2 as indicated in block 50. Next the controller reads the effected memory cells 34 to implement the calculation (block 52). Precision conversion may occur as set forth in the particular opcode.

Next the controller performs the operations specified by the opcode as indicated in block 54. He uses the operands as specified in the opcode and uses memory cells as specified in the opcode in some embodiments. Finally the controller 26 writes the result into the effected memory cells as indicated in block 56.

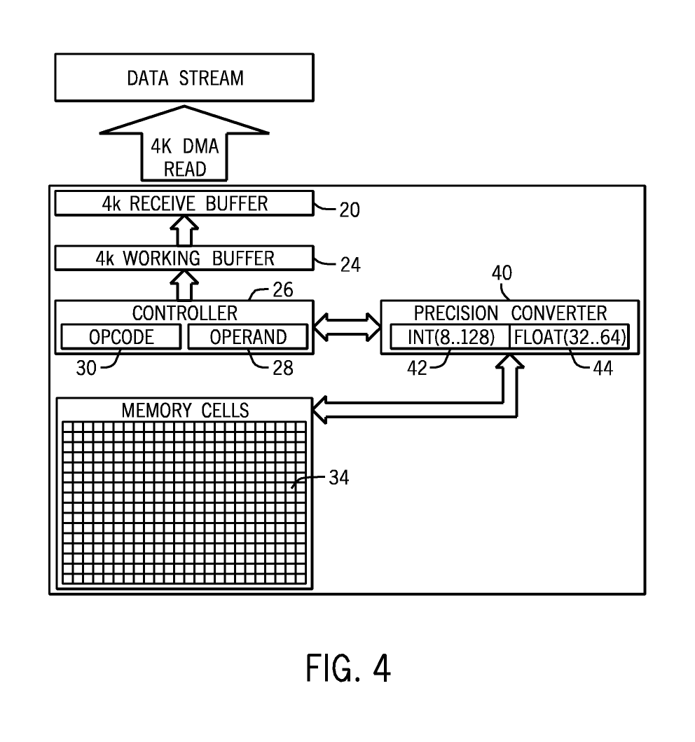

The same thing can be done in the reverse order by using a DMA read operation for data format conversion. Thus looking at FIG. 4, data may be read from the memory cells to the precision converter and passed by the controller to the working buffer 24 to receive buffer 20 and then read out to form a data stream.

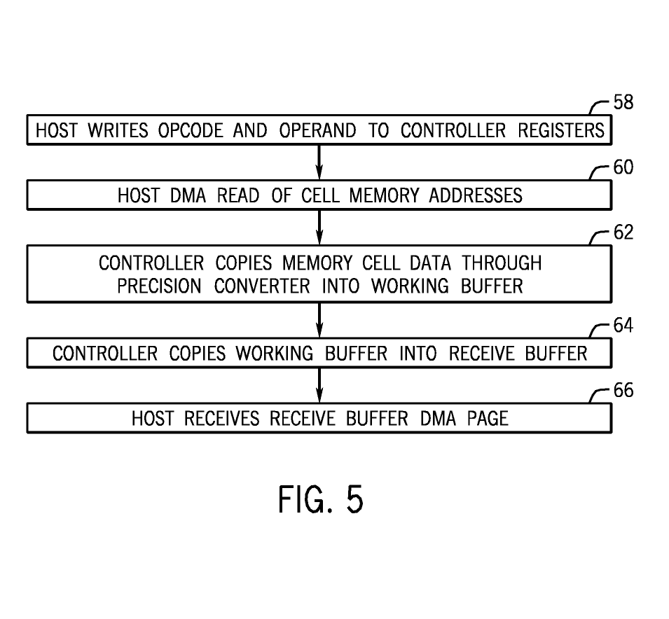

Referring to FIG. 5, the sequence for a streaming data format conversion using a DMA read operation may be implemented in software, firmware and/or hardware. In software and firmware embodiments it may be implemented by computer executed instructions stored in a non-transitory computer readable medium such as semiconductor, optical or magnetic storage. In some embodiments the sequence may be part of the controller 26.

The sequence begins when the host writes opcodes and operands to the controller registers as indicated in block 58. Then there is a host DMA read of the cell memory addresses as indicated in block 60.

Thereafter the controller copies (block 62) memory cell data through the precision converter 40 into the working buffer 24. Next the controller copies a working buffer into the receive buffer as indicated in block 64. Finally the host receives the receive buffer 20 DMA page as indicated in block 66.

While the 4K chunk is used in one embodiment, other chunk sizes may of course be used. The controller then performs the operation on each bit of the chunk in one embodiment

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
programming a plurality of parallel processors with the same operand and the same opcode; and
performing a plurality of parallel operations and storing the results in one line in a memory.

2. The method of claim 1 wherein only data, and not instructions, move along a processing pipeline.

3. The method of claim 1 including performing graphics processing.

4. The method of claim 3 including providing a parallel processor for each row of pixels in a frame.

5. The method of claim 4 including providing a storage cell in said memory for each pixel.

6. The method of claim 5 including converting a two dimensional operation to a one dimensional operation.

7. The method of claim 6 including enabling each processor to perform both a point operation and an accumulation into the storage cell.

8. The method of claim 6 including converting a convolution into a series of point operations with accumulation.

9. The method of claim 6 including performing a precision and numeric conversion in said processors.

10. The method of claim 9 including providing an opcode that indicates an operation, a precision and a numeric conversion.

11. A non-transitory computer readable medium storing instructions to enable a processor to perform a method comprising:
programming a plurality of parallel processors with the same operand and the same opcode; and
performing a plurality of parallel operations and storing the results in one line in a memory.

12. The medium of claim 11 wherein only data, and not instructions, move along a processing pipeline.

13. The medium of claim 11 including performing graphics processing.

14. The medium of claim 13 including providing a parallel processor for each row of pixels in a frame.

15. The medium of claim 14 including providing a storage cell in said memory for each pixel.

16. The medium of claim 15 including converting a two dimensional operation to a one dimensional operation.

17. The medium of claim 16 including enabling each processor to perform both a point operation and an accumulation into the storage cell.

18. The medium of claim 16 including converting a convolution into a series of point operations with accumulation.

19. The medium of claim 16 including performing a precision and numeric conversion in said processors.

20. The medium of claim 19 including providing an opcode that indicates an operation, a precision and a numeric conversion.

21. An apparatus comprising:
a memory array having lines; and
a plurality of parallel processors with the same operand and the same opcode to perform a plurality of parallel operations and store the results in one line in the memory array.

22. The apparatus of claim 21 wherein only data, and not instructions, move along a processing pipeline including said processors.

23. The apparatus of claim 21 wherein said apparatus includes a graphics processing unit.

24. The apparatus of claim 23, including a parallel processor for each row of pixels in a frame.

25. The apparatus of claim 24 including a storage cell in said memory array for each pixel.

26. The apparatus of claim 25, said processors to convert a two dimensional operation to a one dimensional operation.

27. The apparatus of claim 26, said processors to enable each processor to perform both a point operation and an accumulation into the storage cell.

28. The apparatus of claim 26, said processors to convert a convolution into a series of point operations with accumulation.

29. The apparatus of claim 26, said processors to perform a precision and numeric conversion in said processors.

30. The apparatus of claim 29 including said processors to use an opcode that indicates an operation, a precision and a numeric conversion.
